(19) United States
(12) Patent Application Publication
(10) Pub. No.: US 2006/0016753 A1
(43) Pub. Date: Jan. 26, 2006

(54) Biological fluid filter

(75) Inventors: Samuel Sowemimo-Coker, Dix Hills, NY (US); Gerard Del Giacco, Yonkers, NY (US)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 10/532,209

(22) PCT Filed: Oct. 24, 2003
(86) PCT No.: PCT/US03/33700

§ 371 Date: Apr. 22, 2005

Related U.S. Application Data
(60) Provisional application No. 60/421,066, filed on Oct. 25, 2002.

(51) Int. Cl. B01D 61/00

(52) U.S. Cl. 210/651; 210/321.6; 210/323.1; 210/490

(57) ABSTRACT

A biological fluid filter for processing biological fluids wherein the filter includes at least one porous leukocyte depletion filter element comprising a plurality of layers of fibrous porous media, the element having a P8 of at least about 36.8 cm of water, is disclosed.

### CROSS-REFERENCE TO RELATED PATENT APPLICATIONS

This patent application claims the benefit of U.S. Provisional Patent Application No. 60/421,066, filed Oct. 25, 2002, which is incorporated by reference.

### FIELD OF THE INVENTION

This invention pertains to filters for treating biological fluid, preferably leukocyte depletion filters for filtering biological fluids such as whole blood and blood components.

### BACKGROUND OF THE INVENTION

Blood contains a number of components, including red blood cells, platelets, and plasma, as well as various types of white blood cells (leukocytes). Blood components may be separated, and further processed, for a variety of uses, particularly as transfusion products. Illustratively, red blood cells (typically concentrated as packed red blood cells), plasma, and platelets (typically concentrated as platelet concentrate), can be separately administered to patients. Some components, e.g., plasma and/or platelets, can be pooled before administration, and plasma can be further processed, e.g., fractionated to provide enriched components for a variety of uses.

Some processing protocols include filtration to remove leukocytes from the red cells, platelets and/or plasma. However, some filters fail to remove the desired level of leukocytes, fail to provide the desired yield of one or more of the other components and/or provide different results depending on the temperature and/or storage period of the fluid to be filtered. Some filters have an undesirably large hold up volume, or cause processing time to be increased.

The present invention provides for ameliorating at least some of the disadvantages of the prior art. These and other advantages of the present invention will be apparent from the description as set forth below.

### BRIEF SUMMARY OF THE INVENTION

In one embodiment of the invention, a biological fluid filter is provided, comprising at least one porous leukocyte depletion filter element comprising a plurality of layers of fibrous media, the element having a P8 value of at least about 14.5 inches (about 36.8 cm) of water, preferably, wherein the element has a pore diameter in the range of from about 2 micrometers to about 6 micrometers.

In another embodiment, the invention provides a biological fluid filter comprising at least one first leukocyte depletion filter element and at least one second leukocyte depletion filter element, the first and second filter elements each comprising a plurality of layers of fibrous media; the fist leukocyte depletion filter element having a different basis weight than the second leukocyte depletion filter element, each filter element having a basis weight of about 42 g/ft² (about 452 g/m²) or less, wherein at least one element has a P8 value of at least about 14.5 inches (about 36.8 cm) of water.

A biological fluid filter according to another embodiment of the invention comprises two first leukocyte depletion elements and a second leukocyte depletion filter element, wherein the second filter element is interposed between, and adjacent to, the first leukocyte depletion filter elements; the first and second filter elements each comprising a plurality of layers of fibrous media; wherein the second filter element has a higher basis weight and/or a lower P8 value than the adjacent first filter elements. In more preferred embodiments, the second filter element also differs from the adjacent first filter elements with respect to at least one of pore structure, average fiber diameter, average voids volume, and number of layers.

In yet another embodiment, a biological fluid filter is provided, comprising a first leukocyte depletion filter element and two second leukocyte depletion filter elements, wherein the first filter element is interposed between, and adjacent to, the second leukocyte depletion filter elements; the first and second filter elements each comprising a plurality of layers of fibrous media; wherein the first filter element has a lower basis weight and/or a higher P8 value than the adjacent second filter elements. In more preferred embodiment, the first filter element also differs from the adjacent second filter elements with respect to at least one of pore structure, average fiber diameter, average voids volume, and number of layers.

In preferred embodiments, the plurality of layers of fibrous media, and even more preferably, the plurality of leukocyte depletion filter elements, are easily separable from each other.

Filter devices including the filters, systems including the filters and filter devices, and methods of using the filters, filter devices, and systems to leukocyte-deplete biological fluid, preferably, whole blood, are also provided.

### BRIEF DESCRIPTION OF DRAWINGS

FIG. 1 is a schematic view of an embodiment of a filter according to the present invention, showing alternating leukocyte depletion filter elements, wherein a second leukocyte depletion filter element is interposed between two first leukocyte depletion filter elements.

FIG. 2 is a schematic view of another embodiment of a filter according to the resent invention, showing alternating leukocyte depletion filter elements, wherein a first leukocyte depletion filter element is interposed between two second leukocyte depletion filter elements.

FIG. 3 is a schematic view of an embodiment of a filter according to the present invention, showing alternating first and second leukocyte depletion filter elements.

FIG. 4 is a schematic view of an embodiment of an embodiment of a system for processing biological fluid including a leukocyte filter device according to the invention, wherein an additional portion of filtered biological fluid can be recovered from the device.

FIG. 5 is a schematic view of one system used in calculating P8 values.

### DETAILED DESCRIPTION OF THE INVENTION

In an embodiment, a leukocyte depletion filter is provided, comprising at least one porous leukocyte depletion filter element comprising a plurality of layers of fibrous media, the element having a P8 value of at least about 14.5 inches (about 36.8 cm) of water. Preferably, the leukocyte depletion filter element has a pore diameter in the range of from about 2 micrometers to about 6 micrometers.

In another embodiment, a leukocyte depletion filter comprises at least one porous leukocyte depletion filter element comprising a plurality of layers of fibrous media, the element having a P8 in the range of from about 15 to about 18 inches (about 38.1 to about 45.7 cm) of water, a pore diameter in the range of from about 2 micrometers to about 6 micrometers, and a basis weight in the range of from about 15 to about 30 g/ft² (about 161 to about 323 g/m²).

In accordance with another embodiment, a leukocyte depletion filter element is provided, the element comprising a porous fibrous medium comprising at least three layers, each layer having a basis weight in the range of from about 2.2 g/ft² to about 3.1 g/ft² (about 23.7 to about 33.3 g/m²) wherein the fibers have an average fiber diameter of about 3.5 micrometers or less, and wherein the element has a critical wetting surface tension of at least about 75 dynes/cm (0.75 erg/mm²).

In preferred embodiments of the invention, a biological fluid filter is provided. In one embodiment, the filter comprises at least one first porous leukocyte depletion filter element and at least one second porous leukocyte depletion filter element, the first and second filter elements each comprising a plurality of layers of fibrous media; the first filter element having a different basis weight and a higher P8 value than the second filter element; at least one element having a P8 value of at least about 14.5 inches (36.8 cm) of water.

In a more preferred embodiment, the biological fluid filter comprises a plurality of adjacent porous leukocyte depletion filter elements, each element comprising a plurality of layers of fibrous media, wherein, for every pair of adjacent filter elements, the elements differ with respect to at least one of basis weight, P8 value, pore structure, average fiber diameter, average voids volume, and number of layers. More preferably, for every pair of adjacent filter elements, the elements differ from each other with respect to at least one of the P8 value and the basis weight. For example, in an illustrative embodiment, the invention provides a biological fluid filter comprising at least one first leukocyte depletion filter element and at least one second leukocyte depletion filter element, the first and second filter elements each comprising a plurality of layers of fibrous media; the first leukocyte depletion filter element having a different basis weight than the second leukocyte depletion filter element, each filter element having a basis weight of about 42 g/ft² (about 452 g/m²) or less, wherein at least one element has a P8 value of at least about 14.5 inches (about 36.8 cm) of water.

In an embodiment, a biological fluid filter comprises at least three adjacent porous leukocyte depletion filter elements, wherein, for the leukocyte depletion element interposed between the adjacent leukocyte depletion filter elements, the interposed element has at least one of a lower P8 value, a higher basis weight, a higher average voids volume, a larger pore diameter, and a larger average fiber diameter, than that of the adjacent upstream and downstream leukocyte depletion filter elements.

In yet another embodiment of the invention, a biological fluid filter comprises at least three adjacent porous leukocyte depletion filter elements, each element comprising a plurality of layers of fibrous media, wherein, for the leukocyte depletion element interposed between the adjacent leukocyte depletion filter elements, the interposed element has at least one of a higher P8 value, a lower basis weight, a lower average voids volume, a smaller pore diameter, and a smaller average fiber diameter, than that of the adjacent upstream and downstream leukocyte depletion filter elements.

A biological fluid filter according to another embodiment of the invention comprises two first leukocyte depletion elements and a second leukocyte depletion filter element, wherein the second filter element is interposed between, and adjacent to, the first leukocyte depletion filter elements; the first and second filter elements each comprising a plurality of layers of fibrous media; wherein the second filter element has a higher basis weight and/or a lower P8 value than that of each of the adjacent first filter elements. In more preferred embodiments, the second filter element also differs from the adjacent first filter elements with respect to at least one of pore structure, average fiber diameter, average voids volume, and number of layers.

In yet another embodiment, a biological fluid filter comprises a first leukocyte depletion filter element and two second leukocyte depletion filter elements, wherein the first filter element is interposed between, and adjacent to, the second leukocyte depletion filter elements; the first and second filter elements each comprising a plurality of layers of fibrous media; wherein the first filter element has a lower basis weight and/or a higher P8 value than each of the adjacent second filter elements. In more preferred embodiment, the first filter element also differs from the adjacent second filter elements with respect to at least one of pore structure, average fiber diameter, average voids volume, and number of layers.

In preferred embodiments, the plurality of layer of fibrous media, and in even more preferred embodiments, the plurality of leukocyte depletion elements, are easily separable from each other.

In accordance with another embodiment of the invention, the biological fluid filter as described above is disposed in a housing to provide a leukocyte depletion device, the housing having an inlet and an outlet and providing a fluid flow path between the inlet and the outlet, wherein the filter is disposed in the housing across the fluid flow path.

In accordance with yet another embodiment of the invention, the biological fluid filter as described above is disposed in a flexible container to provide a leukocyte depletion device, the container having an inlet and an outlet and providing a fluid flow path between the inlet and the outlet, wherein the filter is disposed in the flexible container across the fluid flow path.

In another embodiment, two biological filters as described above are disposed in a housing to provide a leukocyte depletion device, the housing having an inlet and an outlet and defining first and second fluid flow paths between the inlet and the outlet, wherein one filter is disposed in the housing across the first fluid flow path, and the other filter is disposed in the housing across the second fluid flow path. In an embodiment, the first surface of the one filter opposes, and has at least a portion of the surface spaced apart from, the first surface of the other filter, more preferably, wherein the device essentially lacks a solid partition between the first and second filters. For example, the space between the filters, which typically has a dimension that changes (e.g., a tapered diametric cross-sectional area), can be bounded on one side by the first filter, and bounded on the other side by the second filter.

Embodiments of the invention are particularly suitable for filtering biological fluids containing red blood cells, platelets, plasma and leukocytes, e.g., whole blood, wherein high yields of leukocyte-depleted blood components, especially red blood cells and platelets, are desired.

A method of processing biological fluid according to an embodiment of the invention comprises passing a leukocyte-containing biological fluid through a biological fluid filter including at least one porous leukocyte depletion filter element comprising a plurality of layers of fibrous media, the element having a P8 of at least about 14.5 inches (about 36.8 cm) of water, to deplete leukocytes from the biological fluid. In a more preferred embodiment, the biological fluid is passed through a biological fluid filter comprising at least one first porous leukocyte depletion filter element and at least one second porous leukocyte depletion filter element, the first and second filter elements each comprising a plurality of layers of fibrous media; the first filter element having a different basis weight and a higher P8 value than the second filter element; at least one element having a P8 value of at least about 14.5 inches (about 36.8 cm) of water, to deplete leukocytes from the biological fluid. In one preferred embodiment, the biological fluid passed through the filter is whole blood.

The biological fluid to be filtered can be stored before filtration, if desired. Typically, the biological fluid is filtered within about 24 hours of collection, and in some embodiments, within about 8 hours of collection.

In accordance with another embodiment of the invention, a biological fluid processing system is provided, the system comprising the biological fluid filter, more preferably, the leukocyte depletion device, as described above, and at least one flexible container, such as a blood bag, in fluid communication with the filter or device including the filter. In a typical embodiment of the system, the system includes a biological fluid receiving container comprising a flexible blood bag downstream of the outlet of the leukocyte depletion device. In a more preferred embodiment, the system comprises a closed system including at least two flexible blood bags.

Each of the components of the invention will now be described in more detail below, wherein like components have like reference numbers.

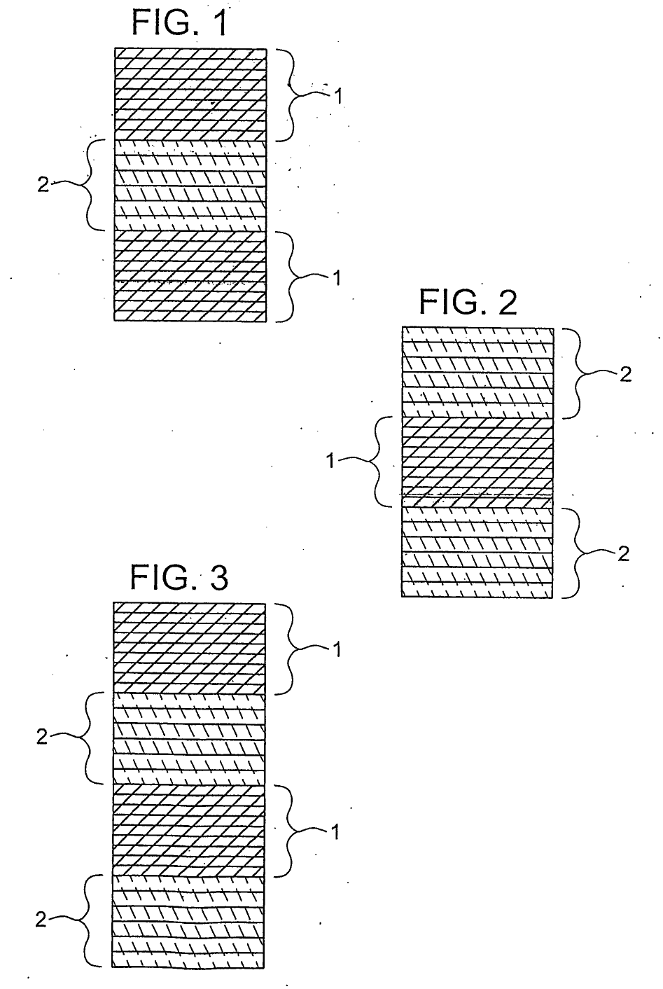

In accordance with preferred embodiments of the invention, the filter includes at least three filter elements (e.g., as illustrated as FIGS. 1-3), each element including two or more fibrous layers (more preferably, wherein the fibrous layers are easily separable, i.e., not tightly bound to one another), wherein for every three adjacent elements, the intermediate element differs from the adjacent upstream and downstream elements with respect to at least one of basis weight, P8 value, pore structure, average fiber diameter, average voids volume, and number of layers. Even more preferably, the intermediate element differs from the adjacent upstream and downstream elements with respect to at least one of basis weight and P8 value.

The upstream and downstream elements adjacent the intermediate element can have the same or different basis weight, P8 value, pore structure, average fiber diameter, average voids volume and/or number of layers, wherein that feature or combination of features is different than the feature or combinations of features of the intermediate element.

This can be illustrated using FIGS. 1-3 for reference, wherein each Figure shows a schematic view of a filter including at least three elements, each element including a plurality of layers. FIG. 1 shows a filter element 2 (a second filter element), interposed between two filter elements 1 (two first filter elements). FIG. 2 shows a filter element 1 interposed between two filter elements 2. FIG. 3, showing four filter elements, shows a filter element 2 interposed between two filter elements 1, and also shows a filter element 1 interposed between two filter elements 2.

In embodiments wherein filter element 2 is interposed between two filter elements 1 (as shown in FIGS. 1 and 3), filter element 2 differs from the adjacent elements 1 with respect to at least one of basis weight, P8 value, pore structure, average fiber diameter, average voids volume, and number of layers. Filter elements 1 can have the same or different basis weight, P8 value, pore structure, average fiber diameter, average voids volume, and/or number of layers, wherein that feature or combination of features is different than the feature or combinations of features of interposed filter element 2. For example, filter element 2 can have a P8 value of about 12 inches (about 30.5 cm) of water, and both filter elements 1 can have a P8 value of about 15 inches (about 38.1 cm) of water, or elements 1 can have different P8 values for the respective elements, e.g., about 14.5 inches (about 36.8 cm) of water for one element, and about 15 inches (about 38.1 cm) of water for the other element. Alternatively, or additionally, filter element 2 can have, for example, a basis weight in the range of from about 32 to about 35 g/ft² (about 344 to about 376 g/m²) and both filter elements 1 can have a basis weight in the range of from about 22 to about 28 g/ft² (about 237 to about 301 g/m²) or filter elements 1 can have different basis weights, e.g., in the range of from about 23 to about 25 g/ft² (about 247 to about 269 g/m²) and in the range of from about 26 g/ft² to about 28 g/ft² (about 280 to about 301 g/m²) respectively.

Similarly, in those embodiments wherein filter element 1 is interposed between two filter elements 2 (as shown in FIGS. 2 and 3), filter element 1 differs from the adjacent elements 2 with respect to at least one of basis weight, P8 value, pore structure, average fiber diameter, average voids volume, and number of layers. Filter elements 2 can have the same or different basis weight, P8 value, pore structure, average fiber diameter, average voids volume, and/or number of layers, wherein that feature or combination of features is different than the feature or combinations of features of interposed filter element 1. For example, filter element 1 can have a P8 of about 14.5 inches (about 36.8 cm) of water, and both filter elements 2 can have a P8 value of about 12 inches (about 30.5 cm) of water, or elements 2 can have different P8 values for the respective elements, e.g., about 11.5 inches (about 29.2 cm) of water for one element and about 13 inches (about 33 cm) of water for the other element. Alternatively, or additionally, filter element 1 can have, for example, a basis weight in the range of from about 23 to about 27 g/ft² (about 247 to about 290 g/m²) and both filter elements 2 can have a basis weight in the range of from about 31 to about 39 g/ft² (about 333 to about 419 g/m²) or filter elements 2 can have different basis weights, e.g., in the range of from about 32 to about 35 g/ft² (about 344 to about 376 g/m²) and in the range of from about 37 g/ft² to about 39 g/ft² (about 398 to about 419 g/m²) respectively.

The filter can have any number of first and/or second elements, and either element can be the most upstream or downstream. The filter can include alternating and non-alternating filter elements.

In one more preferred embodiment, the filter includes a plurality of alternating first and second elements, e.g., first element, second element, first element, second element (e.g., as shown in FIG. 3), wherein the first elements each have a greater P8 value and/or a lower basis weight than the P8 value and/or basis weight for the second elements.

Without being limited to any particular mechanism, it is believed the alternating arrangement provides a plurality of flow paths for the various blood components, allowing more efficient separation of the components from each other (while retaining leukocytes) and more efficient passage of the desired components. Additionally, or alternatively, while the mechanism is not understood, and without being limited thereby, it is believed this arrangement may reduce platelet activation (thus, increasing the yield of optimum quality filtered platelets), while increasing leukocyte activation and/or increasing activation of at least one subset of leukocytes (thus, retaining a greater percentage of leukocytes as activated leukocytes may be even more efficiently adsorbed by the filter element(s)).

As noted above, in a preferred embodiment, each element comprises a plurality of fibrous layers wherein the layers are easily separable from each other. In accordance with the invention, layers are easily separable from each other wherein, for example, the major surfaces of the layers are not bound, or not tightly bound, to one another by, e.g., heating, calendering, and/or adhesives. Typically, for example, the contacting surfaces of adjacent layers are not thermally or adhesively bound to each other, and the layers are not calendered together. Illustratively, at least about 85%, preferably, at least about 95%, even more preferably, at least about 98% of the surface area of the contacting surfaces of adjacent layers are not bound to each other. While, for example, the outer edges or outer perimeters of the major surfaces of the adjacent layers contacting each other can be compressed together, the layers can be easily separated. In an even more preferred embodiment, the filter elements are also easily separable from each other. Without being bound to a particular mechanism, it is believed the use of unbound layers (and elements) exposes the components of the biological fluid to more filter surface area, surprisingly without unduly increasing the hold up volume of the filter.

In accordance with a preferred embodiment of a method for processing a biological fluid according to the invention, a red blood cell- and/or platelet-containing biological fluid, more preferably, a red blood cell- and platelet-containing biological fluid, even more preferably, whole blood, is passed through a biological fluid filter as described above, to provide a leukocyte-depleted biological fluid.

In a more preferred embodiment, the filtered leukocyte-depleted biological fluid is obtained in a closed system. Even more preferably, the leukocyte-depleted biological fluid is further processed, typically, including centrifugation, e.g., to separate various leukocyte-depleted biological fluid components, for example, to provide leukocyte-depleted packed red blood cells (PRC), leukocyte-depleted platelet concentrate (PC) and/or leukocyte-depleted plasma.

Some embodiments of the invention provide leukocyte-depleted biological fluid (e.g., at least one of PRC, PC, and plasma) wherein the leukocyte-depleted biological fluid has less than 5×10⁶ residual leukocytes per unit of biological fluid, and an embodiment can provide less than 1×10⁶ residual leukocytes per unit of biological fluid.

Preferred embodiments of the invention provide leukocyte-depleted (leukocyte reduced) PRC, PC, and plasma, wherein these blood components have less than 5×10⁶ residual leukocytes per unit of blood component, and wherein at least 75% of the units of PC have at least 5.5×10¹⁰ platelets per unit. In more preferred embodiments, at least 90% of the units of PC have at least 5.5×10¹⁰ platelets per unit and have less than 5×10⁶ residual leukocytes per unit.

Some embodiments of the invention provide leukocyte reduced PRC, PC, and plasma wherein these blood components have less than 1×10⁶ residual leukocytes per unit of blood component, and wherein at least 75% of the units of PC have at least 6×10¹⁰ platelets per unit.

In accordance with embodiments of the invention, these results can be obtained in accordance with, for example, PRP processing at room temperature, as well as “buffy coat” processing and the use of cooling plates, and with stored and with fresh blood.

The following definitions are used in accordance with the invention.

Biological Fluid. A biological fluid includes any treated or untreated fluid associated with living organisms, particularly blood, including whole blood, warm or cold blood, and stored or fresh blood; treated blood, such as blood diluted with at least one physiological solution, including but not limited to saline, nutrient, and/or anticoagulant solutions; blood components, such as platelet concentrate (PC), platelet-rich plasma (PRP), platelet-poor plasma (PPP), platelet-free plasma, plasma, fresh frozen plasma (FFP), components obtained from plasma, packed red cells (PRC), transition zone material or buffy coat (BC); blood products derived from blood or a blood component or derived from bone marrow; stem cells; red cells separated from plasma and resuspended in physiological fluid or a cryoprotective fluid; and platelets separated from plasma and resuspended in physiological fluid or a cryoprotective fluid. The biological fluid may have been treated to remove some of the leukocytes before being processed according to the invention. As used herein, blood product or biological fluid refers to the components described above, and to similar blood products or biological fluids obtained by other means and with similar properties.

A “unit” is the quantity of biological fluid from a donor or derived from one unit of whole blood. It may also refer to the quantity drawn during a single donation. Typically, the volume of a unit varies, the amount differing from patient to patient and from donation to donation. Multiple units of some blood components, particularly platelets and buffy coat, may be pooled or combined, typically by combining four or more units. In accordance with some embodiments of the invention, more than one unit can be separately passed through the biological fluid filter.

As used herein, the term “closed” refers to a system that allows the collection and processing (and, if desired, the manipulation, e.g., separation of portions, separation into components, filtration, storage, and preservation) of biological fluid, e.g., donor blood, blood samples, and/or blood components, without the need to compromise the integrity of the system. A closed system can be as originally made, or result from the connection of system components using what are known as “sterile docling” devices. Illustrative sterile docking devices are disclosed in U.S. Pat. Nos. 4,507,119, 4,737,214, and 4,913,756.

In accordance with the invention, a specific method of measuring pressure drop is used that normalizes both the weight and the voids volume of a sample of fibrous media, permitting meaningful comparisons between different samples. This method yields a value, called P8, that can be used to characterize filter layers and filter elements. As a result, the filter elements (and thus, the filters) can be optimized in a well defined manner for particular applications.

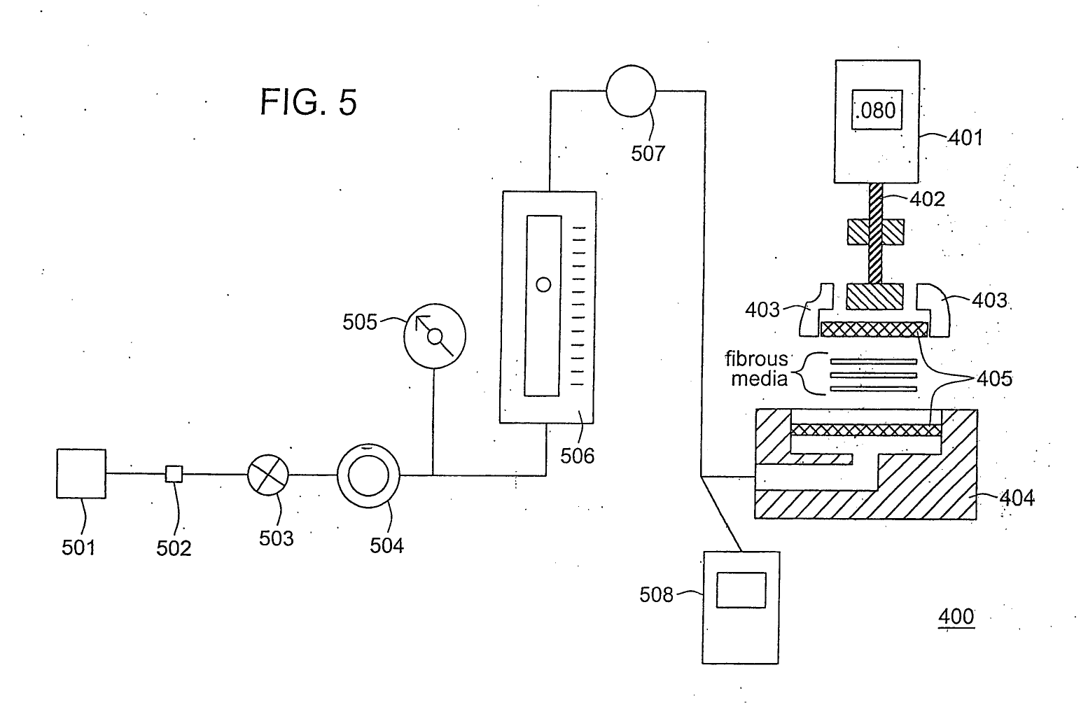

The P8 value is determined using a test apparatus connected to an adjustable test jig assembly (e.g., an illustrative jig assembly and an illustrative test apparatus are shown schematically in FIG. 5) having a standardized area and volume. The illustrated test apparatus 500 includes a cleanup filter 502, an on/off valve 503, a pressure regulator 504, at least one pressure gauge 505, a flow meter 506, a flow control (needle) valve 507, and a pressure measuring device 508 (e.g., an electronic pressure sensor). Compressed air is passed from a tank 501 through the test apparatus 500 into the jig assembly 400 that contains the fibrous sample to be tested.

The illustrated jig assembly 400 includes a measuring gauge 401 (illustrated as a digital measuring gauge), an adjusting screw 402, a top assembly 403, a bottom assembly 404, and support screens 405. The fibrous sample to be characterized is placed between the support screens 405 and the jig assembly is adjusted.

By way of an example, the adjustable jig assembly is set initially to a gap of 0.080 inches (the “8” in P8). For a jig assembly 3.059 inches in diameter, the volume of the space in the jig is:
(3.059 inches)²×(π/4)×(0.080 inches)×(16.4 cm³/in³)=9.64 cc.

To normalize the volume of fibers in the jig assembly, the volume of the space in the jig is multiplied by the solids fraction (SF) of the test sample. For a test sample having an average voids volume of 84.7%, the SF is (100%−84.7%) or 15.3%. Multiplying the SF (0.153) by the jig assembly volume (9.64 cc) provides the cc's of fibers required to fill the volume of space in the jig assembly, in this example, 1.475 cc (=0.153×9.64 cc) of fibers are required.

So, for samples made from the resin polybutylene terephthalate (PBT) which has a density of 1.356 g/cc, the density (1.356 g/cc) multiplied by the cc's of fibers required to fill the space in the jig assembly (1.475 cc) provides the target weight of sample, in this case, 2 grams.

Layers of media made from PBT fibers are cut and stacked until the weight of the stack comes a close as possible to the target weight of 2 grams. Illustratively, since the area in the jig assembly is nearly 1/20 of a square foot (0.051 ft²), multiplying the basis weight of the sample media (in g/ft²) by 1/20 provides the weight in grams per layer. For example, for a filter layer having a basis weight of 2.9 g/ft², multiplying the basis weight by 1/20 ft² provides 0.145 grams/layer. Multiplying the target weight of 2 grams by 1/0.145 grams/layer equals 13.79 layers.

In this example, 13.79 is not an integral number of layers, so a more convenient number can be chosen. This can be done while providing meaningful results because the thickness (t) of the jig opening (initially set at 0.080 inches) can be scaled to match the actual weight used as follows:
t=(actual weight in grams/2 grams)×0.080 inches.

Accordingly, the desired number of layers are placed in the jig assembly, compressed air is passed through the test apparatus in accordance with the manufacturer's instructions (e.g., as described in Example 1, below), and the delta P is measured.

To obtain the P8 value (in this example, the target weight is 2 grams):
P8=(target weight/actual disc weight)×(measured delta P).

The target weight for testing various materials, e.g., polymers, can be calculated as shown in the following Table (listing illustrative resins). Other materials suitable for use with biological fluids can be selected as is known in the art. Since the method for measuring pressure drop and providing the P8 value is easily scalable, one of ordinary skill in the art recognizes that the target weight for any material can be within a given range. Illustratively, the target weight for PBT can be, for example, from about 1 to about 2.5 grams.

| Resin | Density (g/cc) | Target Weight (g) |
|---|---|---|
| Polyethylene | 1.33 | 2.0 |
| terephthalate | | |
| (PET) | | |
| Polypropylene | 0.91 | 1.3 |
| Polyurethane | 1.16 | 1.7 |
| Nylon 6 | 1.13 | 1.7 |
| Nylon 66 | 1.14 | 1.7 |

In accordance with preferred embodiments of the invention, at least one leukocyte depletion filter element has a P8 value of at least about 14.5 inches (about 36.8 cm) of water, more preferably, a P8 value of at least about 15 inches (about 38.1 cm) of water.

In more preferred embodiments of the invention, wherein a biological fluid filter is provided, having at least two leukocyte depletion filter elements wherein each filter element has a plurality of layers of fibrous media, at least one leukocyte depletion filter element has a P8 value of at least about 14.5 inches (about 36.8 cm) of water (even more preferably, a P8 value of at least about 15 inches (about 38.1 cm) of water, e.g., in the range of about 15 inches (about 38.1 cm) to about 18 inches (about 45.7 cm) of water), and at least one other leukocyte depletion filter element has a P8 value of about 13.5 inches (about 34.3 cm) of water or less (even more preferably, a P8 value of about 13 inches (about 33 cm) of water or less, e.g., in the range of about 11 inches (about 27.9 cm) to about 13 inches (about 33 cm)).

In accordance with preferred elements of the invention, each of the leukocyte depletion filter elements has a basis weight of about 42 g/ft² (about 452 g/m²) or less, more preferably, about 40 g/ft² (about 430 g/m²) or less. Typically, each of the leukocyte depletion elements has a basis weight of at least about 8 g/ft² (about 86 g/m²).

In some embodiments of the invention wherein a biological fluid filter is provided comprising at least one first leukocyte depletion filter element and at least one second leukocyte depletion filter element, at least one first leukocyte depletion filter element has a P8 value of at least about 14.5 inches (about 36.8 cm) of water and a basis weight of at least about 15 g/ft² (about 161 g/m²), e.g., in the range of from about 20 to about 27 g/ft² (about 215 to about 290 g/m²) or, for example, in the range of from about 22 to about 25 g/ft² (about 237 to about 269 g/m²) or from about 26 g/ft² to about 27 g/ft² (about 280 to about 290 g/m²) and, at least one second leukocyte depletion filter element has a P8 value of about 13 inches (about 33 cm) of water or less, and the element has a basis weight in the range of from about 30 to about 39 g/ft² (about 323 to about 419 g/m²) or, for example, in the range of from about 31 to about 35 g/ft² (about 333 to about 376 g/m²) or about 37 g/ft² to about 39 g/ft² (about 398 to about 419 g/m²).

Preferably, each of the leukocyte depletion filter elements having a plurality of fibrous layers according to the invention comprises at least 3 layers of fibrous media, more preferably, at least 4 layers, even more preferably, at least 5 layers, and in some embodiments, at least 6 layers. Typically, the first leukocyte depletion filter element has a greater number of layers than the second leukocyte depletion filter element.

In some embodiments comprising at least one first leukocyte depletion filter element and at least one second leukocyte depletion filter element, the at least one first leukocyte depletion element includes at least four layers of fibrous media, each layer having a basis weight in the range of from about 2.2 g/ft² to about 3.1 g/ft² (about 23.7 to about 33.3 g/m²) and the at least one second leukocyte depletion filter element includes at least four layers of fibrous media, each layer having a basis weight in the range of from about 4.8 g/ft² to about 5.8 g/ft² (about 51.6 to about 62.4 g/m²).

The filter and filter element(s) can have any suitable pore structure, e.g., a pore size (for example, as evidenced by bubble point, or by K_{L} as described in, for example, U.S. Pat. No. 4,340,479), a pore rating, or a pore diameter (e.g., when characterized using the modified OSU F2 test as described in, for example, U.S. Pat. Nos. 4,925,572 and 5,229,012), that allows the passage therethrough of one or more components of interest as the fluid is passed through the element. While it is believed leukocytes are primarily removed by adsorption, they can also be removed by filtration. The pore structure can be selected to remove at least some level of leukocytes, while allowing the passing therethrough of desired components, e.g., at least one of red blood cells, platelets, and plasma. The pore structure used depends on the composition of the biological fluid to be filtered, and the desired effluent level of the filtered biological fluid.

In preferred embodiments, wherein the biological fluid to be treated includes red blood cells, platelets and plasma, e.g., whole blood, each filter element has a pore diameter (when characterized by the modified OSU F2 test) in the range of from about 2 to about 9 micrometers, more preferably, in the range of from about 2 to about 6 micrometers, even more preferably, in the range of from about 3 to about 5 micrometers. In preferred embodiments wherein the biological fluid to be treated includes red blood cells, platelets, and plasma, the filter (i.e., including a plurality of filter elements), has a pore diameter in the range of from about 1 to about 5 micrometers, more preferably, in the range of from about 2 to about 4 micrometers.

The filter elements can have any desired critical wetting surface tension (CWST, as defined in, for example, U.S. Pat. Nos. 4,925,572 and 4,880,548). The CWST can be selected as is known in the art, e.g., as additionally disclosed in, for example, U.S. Pat. Nos. 5,152,905, 5,443,743, 5,472,621, and 6,074,869. The filter elements can have the same or different CWSTs, and filters having plurality of elements can have a plurality of elements having the same and/or different CWSTs. Typically, at least one, and preferably, each of the filter elements, has a CWST of greater than about 75 dynes/cm (about 0.75 erg/mm²), more typically greater than about 82 dynes/cm (about 0.82 erg/mm²) and can have a CWST of about 86 dynes/cm (about 0.86 erg/mm²) or more.

Preferably, each of the elements has a CWST in the range from about 80 dynes/cm to about 115 dynes/cm (about 0.80 erg/mm² to about 1.62 erg/mm²), e.g., in the range of about 82 to about 100 dynes/cm (about 0.82 to about 1.00 erg/mm²). In some embodiments, each of the elements has a CWST in the range of from about 85 to about 95 dynes/cm (about 0.85 to about 0.95 erg/mm²).

The surface characteristics of the element(s) can be modified (e.g., to affect the CWST, to include a surface charge, e.g., a positive or negative charge, and/or to alter the polarity or hydrophilicity of the surface) by wet or dry oxidation, by coating or depositing a polymer on the surface, or by a grafting reaction. Modifications include, e.g., irradiation, a polar or charged monomer, coating and/or curing the surface with a charged polymer, and carrying out chemical modification to attach functional groups on the surface. Grafting reactions may be activated by exposure to an energy source such as gas plasma, heat, a Van der Graff generator, ultraviolet light, electron beam, or to various other forms of radiation, or by surface etching or deposition using a plasma treatment.

In an embodiment, at least one leukocyte depletion filter element comprises a fibrous medium that has been treated (e.g., surface modified) to include a high density of hydroxyl groups, more preferably, to also include anionic groups, e.g., some carboxyl groups as well as the high density of hydroxyl groups. In some embodiments, the first and second filter elements comprise fibrous media that has been so treated.

For example, the first and/or second element can have a hydroxylated surface, and in an embodiment, has a grafted coating comprising hydroxyl groups, e.g., comprising an hydroxylated polymer, such as, but not limited to, an hydroxyl acrylate polymer. In some embodiments including a hydroxylated polymer, the polymer further comprises carboxyl groups, e.g., a copolymer including a hydroxyl-containing monomer and a carboxyl containing monomer, such as, but not limited to, a copolymer of hydroxyalkylacrylate and acrylic acid.

In an exemplary technique, at least one of a variety of monomers each comprising an ethylene or acrylic moiety and a second group, which can be selected from hydrophilic groups (e.g., —COOH, or —OH) are used, e.g., in radiation grafting. Grafting of the medium can also be accomplished by compounds containing an ethylenically unsaturated group, such as an acrylic moiety, combined with a hydroxyl group, e.g., monomers such as hydroxyethyl methacrylate (HEMA) or acrylic acid. The compounds containing an ethylenically unsaturated group may be combined with a second monomer such as methacrylic acid (MAA), In an embodiment, the fibrous medium is surface modified using a mixture including hydroxyl-terminated and carboxyl-terminated monomers.

Illustrative compounds and groups, e.g., hydroxyl groups and carboxyl groups, as well as illustrative medium treatment protocols include, but are not limited to, those disclosed in U.S. Pat. Nos. 5,152,905, 4,880,548 and 4,925,572, as well as International Publication No. WO 91/04088.

In some embodiments, at least one element, and typically, both the first and second filter elements, has a negative zeta potential at physiological pH (e.g., about 7 to about 7.4). For example, the first and/or second filter element can have a zeta potential of about −3 millivolts (mv), at physiological pH, or the zeta potential can be more negative, e.g., in the range of from about −5 mv to about −25 mv. In some embodiments, the first and/or second filter element has a zeta potential in the range from about −8 mv to about −20 mv at physiological pH. In some embodiments wherein both elements have a negative zeta potential at physiological pH, one element can have a zeta potential that is more negative than that of the other element.

Typically, each leukocyte depletion filter element in accordance with the invention has an average fiber surface area, as determined by gas adsorption (Brunauer-Emmett-Teller (BET) measurement), of at least about 0.8 m²/g, more preferably, at least about 0.9 m²/g, even more preferably, at least about 0.95 m²/g.

Preferably, the average fiber diameter of the fibers in the leukocyte depletion elements is about 5 micrometers or less (calculated from, for example, the average fiber surface area), more preferably, about 4 micrometers or less, even more preferably, about 3.5 micrometers or less. Even more preferably, the leukocyte filter element or elements having a P8 value of at least about 14.5 inches (about 36.8 cm) of water have fibers with an average fiber diameter of less than 3 micrometers, e.g., in the range of from about 1.5 micrometers to less than 3 micrometers, and the leukocyte filter element or elements having a P8 value of about 13.5 inches (about 34.3 cm) of water or less have fibers with an average fiber diameter of 3 micrometers or more, e.g., in the range of from 3 to about 5 micrometers.

Typically, each leukocyte depletion filter element has an average voids volume of at least about 75%, in some embodiments, each element has an average voids volume of at least about 85%.

A variety of materials can be used, including synthetic polymeric materials, to produce the fibrous porous media of the filter elements according to the invention. Suitable synthetic polymeric materials include, for example, polybutylene terephthalate (PBT), polyethylene, polyethylene terephthalate (PET), polypropylene, polymethylpentene, polyvinylidene fluoride, polysulfone, polyethersulfone, nylon 6, nylon 66, nylon 6T, nylon 612, nylon 11, and nylon 6 copolymers, wherein polyesters, e.g., PBT and PET, are more preferred. Typically, the fibrous porous media are prepared from melt-blown fibers. For example, U.S. Pat. Nos. 4,880,548; 4,925,572, 5,152,905, and 6,074,869, disclose porous filter elements prepared from melt-blown fibers.

The filter, comprising a plurality of filter elements, is disposed in a housing comprising at least one inlet and at least one outlet and defining at least one fluid flow path between the inlet and the outlet, wherein the filter is across the fluid flow path, to provide a filter device. Preferably, the filter device is sterilizable. Any housing of suitable shape to provide at least one inlet and at least one outlet may be employed.

Suitable housings include, but are not limited to, those disclosed in U.S. Pat. Nos. 4,880,548, 4,25,572 and 5,600,731.

In some embodiments, e.g., wherein the housing defines a first fluid flow path and a second fluid flow path, and includes a first biological fluid filter across the first fluid flow path and a second biological fluid filter across the second fluid flow path, suitable housings include, for example, those disclosed in U.S. Pat. No. 6,231,770 (that also discloses suitable two filter configurations, as well as sealing the filters in the housing). Typically, the first surface of the one filter opposes, and has at least a portion of the surface spaced apart from, the first surface of the other filter, more preferably, wherein the device essentially lacks a solid partition between the first and second filters. For example, the space between the filters, which typically has a dimension that changes (e.g., a tapered diametric cross-sectional area), can be bounded on one side by the first filter, and bounded on the other side by the second filter. However, in other embodiments, the device can include a solid partition between the first and second filters.

A variety of device housing shapes are suitable for use in the invention. For example, the housing may be generally circular, oval, triangular, rectangular or square in shape. In some embodiments, e.g., wherein the filter device is part of a system including one or more blood bags, and the system is centrifuged, a generally circular or oval planar shape can be preferable. For example, a circular or oval planar device can be easier to fit in the centrifuge cup with a plurality of blood bags, and/or the circular or oval shape minimizes or eliminates corners that can contact and damage the blood bag during centrifugation.

The housing can be fabricated from any suitable rigid impervious material, including any impervious thermoplastic material, which is compatible with the biological fluid being processed. For example, the housing can be a polymer, more preferably a transparent or translucent polymer, such as an acrylic, polypropylene, polystyrene, or a polycarbonated resin. Such a housing is easily and economically fabricated, and allows observation of the passage of the biological fluid through the housing.

The surfaces of the housing contacting the fluid may be treated or untreated. For example, the surfaces of the housing contacting the fluid may be rendered liquophilic for better priming. Methods for treating the surface of the housing include but are not limited to radiation grafting and gas plasma treatment.

In another embodiment, the filter, comprising a plurality of filter elements, is disposed in a flexible housing, e.g., a flexible container, comprising at least one inlet and at least one outlet and defining at least one fluid flow path between the inlet and the outlet, wherein the filter is disposed across the fluid flow path, to provide a filter device. Suitable flexible containers can be fabricated from, for example, polymeric materials such as films identical to or similar to those used in forming blood bags, such as plasticized polyvinyl chloride, plasticized ultra-high-molecular weight PVC resin, ethylene butyl acrylate copolymer (EBAC) resin, ethylene methyl acrylate copolymer (EMAC) resin, and ethylene vinyl acetate (EVA).

Typically, the filter device according to the invention is included in a biological fluid processing system, e.g., a system including a plurality of conduits and containers, preferably flexible containers such as blood bags (e.g., collection bags and/or satellite bags). In one preferred embodiment, a system according to the invention comprises a closed system. A wide variety of suitable containers and conduits are known in the art. For example, blood collection and satellite bags, and conduits, can be made from plasticized polyvinyl chloride. Bags and/or conduits can also be made from, for example, ethylene butyl acrylate copolymer (EBAC) resin, ethylene methyl acrylate copolymer (EMAC) resin, plasticized ultra-high-molecular weight PVC resin, and ethylene vinyl acetate (EVA). The bags and/or conduits can also be formed from, for example, polyolefin, polyurethane, polyester, and polycarbonate.

In one embodiment, the filter device is included in a biological processing system that provides for filtration during donation, e.g., wherein anticoagulant is mixed with the blood withdrawn from the donor during donation and the mixture is passed through the filter into a container such as a blood bag.

In accordance with embodiments of a method for processing a biological fluid according to the invention, a biological fluid, typically a red blood cell- and/or platelet-containing biological fluid, preferably, a red blood cell and platelet-containing biological fluid, even more preferably, whole blood, is passed through the biological fluid filter, to provide a leukocyte-depleted biological fluid. In a more preferred embodiment, the filtered leukocyte-depleted biological fluid is obtained in a closed system.

In accordance with embodiments of the invention, the leukocyte-depleted biological fluid can be further processed, typically, including centrifugation, e.g., to separate various leukocyte-depleted biological fluid components, for example, to provide leukocyte-depleted packed red blood cells (PRC), leukocyte-depleted platelet concentrate (PC) and/or leukocyte-depleted plasma suitable for storage.

In some embodiments, a portion of the biological fluid remaining in the leukocyte depletion filter device after the initial filtration is subsequently recovered. For example, one or more gas inlets and/or gas outlets can be utilized to vent the device and allow additional fluid to be recovered. Alternatively, or additionally, fluid that is compatible with the biological fluid can be introduced into the filter device to loosen desired components (e.g., platelets) and flush and/or displace some of the desired biological fluid from the filter device to a desired location, e.g., into a receiving container downstream of the filter device. Compatible fluids include, for example, saline, and anticoagulant solutions (e.g., CPD, and CP2D). Fluid can be introduced into the filter device via, for example, at least one of gravity, using a pump, and using an expressor (including, but not limited to, the expressor disclosed in U.S. Pat. No. 5,690,815). The pump or expressor can be disposed upstream or downstream of the filter.

In one embodiment, this fluid, hereinafter referred to as the “flushing fluid,” is utilized with a filter according to the invention in an apheresis system (e.g., including, but not limited to, the Baxter Fenwall Amicus® Separator, Baxter Fenwall CS 3000 plus, Gambro BCT OrbiSac system, and the Haemonetics Corp. MCS®+) to flush and/or displace some of the desired biological fluid from the filter.

In another embodiment, the flushing fluid is disposed in a container or a compartment of a container that also contains sterile air, and the system is arranged such that the flushing fluid is directed to the filter device to displace a volume of held up filtered biological fluid, and the sterile air following the flushing fluid contacts the wetted filter. Since the air will not pass through the wetted filter, flow stops. In a more preferred embodiment, the volume of flushing fluid is less than the hold up volume of the filter device, and thus, flushing fluid will not be collected in the downstream receiving container.

In some embodiments, the flushing fluid can be utilized in an automated protocol to recover desired biological fluid.

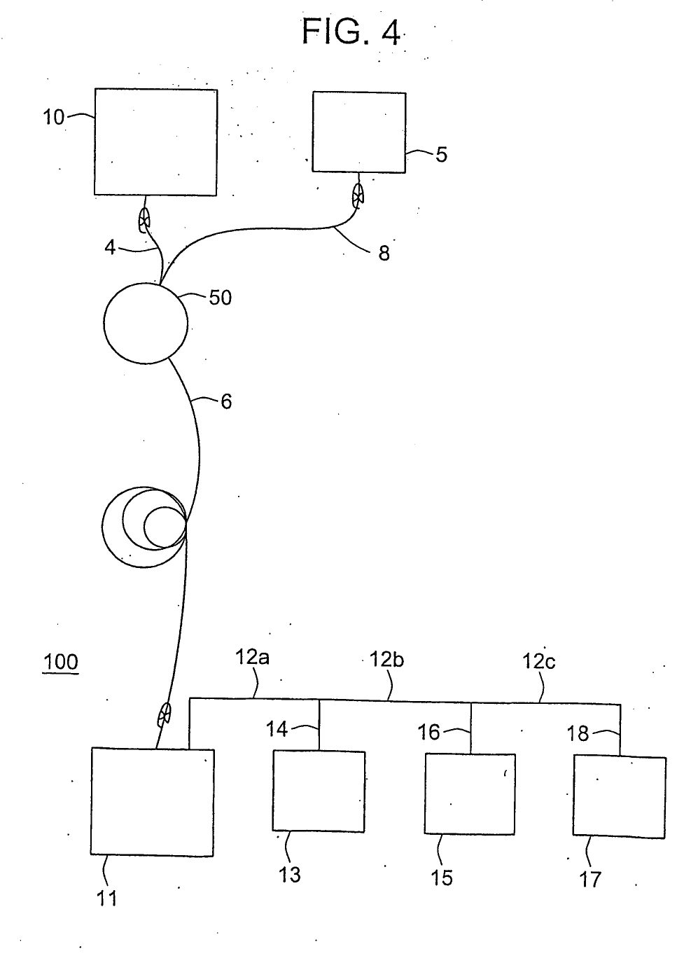

FIG. 4 shows an embodiment of a system for flushing or displacing fluid from the filter device. In exemplary variations of the system (not shown), the collection bag can include a compartment for the flushing fluid, or one of the satellite bags can be used for both adding the flushing fluid, and containing a separated biological fluid component, e.g., leukocyte depleted plasma.

The following examples further illustrate the invention but, of course, should not be construed as in any way limiting its scope.

### EXAMPLE 1

This example demonstrates filters according to embodiments of the invention efficiently leukocyte-deplete whole blood while providing a desirable yield of platelets, red blood cells, and plasma.

A plurality of filters are prepared and arranged in housings to provide filter devices. Each filter includes two first porous filter elements and two second porous filter elements.

The P8 values listed below for the filter elements are determined according to the equations and procedure described earlier, and using the test apparatus 500 and jig assembly 400 shown schematically in FIG. 5. A tank 501 of compressed air is attached to the apparatus, that includes a cleanup filter 502, an on/off valve 503, a pressure regulator 504, at least one pressure gauge 505, a flow meter 506, a flow control (needle) valve 507, and an electronic pressure sensor 508. The air is passed into a jig assembly 400 that contains the filter elements to be tested and the delta P is measured.

Compressed air (approximately 100 psig) is passed through a cleanup filter, through a valve (when the valve is in the on position) and through a pressure regulator, a flowmeter, a flow control valve, and to the jig assembly. In accordance with the manufacturer's instructions for proper calibration of the flowmeter (downstream of the regulator), the regulator is set at 44 psig. The needle valve downstream of the flowmeter is adjusted to provide a filter face velocity of 28 ft/min/ft². Since, as described above, the area of the jig assembly is 1/20th of a square foot, the needle valve is adjusted to provide a flow rate of 1.4 standard cubic feet per minute (SCFM, which is 1/20th of 28 ft/min/ft². The differential pressure is measured at 1.4 SCFM, and the P8 value is calculated.

The first and second elements are produced from melt-blown polybutylene terephthalate (PBT) fibers. The fibers are surface modified as described in U.S. Pat. No. 4,880,548 to provide first and second elements having a CWST of 91 dynes/cm (0.91 erg/mm²).

The first elements each have 9 layers of fibrous PBT media, the fibers having an average fiber diameter of 2.7 micrometers. The fibrous layers, that are easily separable from each other (e.g., they not calendered, adhesively bound, or exposed to increased heat to bind layers to each other), have a basis weight of 2.7 g/ft² per layer. The first elements each have a thickness of 55.9 mils (about 1420 micrometers), an average voids volume of 85.3%, a pore diameter (as determined by the modified OSU F2 test) of 3.8 micrometers, and a fiber surface area (as determined by BET measurement) of 1.2 m²/g. The P8 value is 16 inches of water.

The second elements each have 6 layers of fibrous PBT media, the fibers having an average fiber diameter of 3 micrometers. The fibrous layers, that are easily separable from each other (as described with respect to the first elements), have a basis weight of 5.2 g/ft² per layer. The second elements each have a thickness of 86.9 mils (about 2207 micrometers), an average voids volume of 87.7%, a pore diameter (as determined by the modified OSU F2 test) of 4.2 micrometers, and a fiber surface area (as determined by BET measurement) of 0.95 m²/g. The P8 value is 12 inches of water.

The elements are placed in an alternating arrangement as generally illustrated in FIG. 3: the most upstream element (the element that is first to be contacted by the blood), being a first element, followed by a second element, a first element, and the most downstream element (the last element to be contacted by the blood) being a second element, to provide a filter. The elements are easily separable from each other. The filter has a thickness of 281.6 mils (about 7153 micrometers).

Each filter is disposed in a housing wherein the filter is across the fluid flow path between the inlet and the outlet, and units of anticoagulated whole blood (about 450 cc, plus 63 mL of Citrate Phosphate Double Dextrose (CP2D) anticoagulant), disposed in collection bags at a head height of 30 inches (76.2 cm), are filtered at room temperature.

The filtered (leukocyte-depleted) units received in the downstream receiving bags are centrifuged and separated according to standard North American blood bank procedures to provide packed red blood cells (ARC), plasma, and platelet concentrate (PC). The concentrations of residual white blood cells (WBCs) in each of the three components are determined via flow cytometry, and the following parameters are measured: platelet activation, platelet extent of shape change (ESC), platelet hypotonic shock response (HSR), red cell hemolysis, red cell deformability, and plasma hemoglobin content. Additionally, the platelet count is determined for each unit of PC.

The leukocyte-depleted blood components have less than 5.0×10⁶ residual leukocytes per unit, and over 75% of the units of PC have at least 5.5×10¹⁰ platelets per unit. The measured parameters are normal.

This example shows whole blood can be efficiently leukocyte depleted via a single leukocyte depletion filter, while providing leukocyte-depleted processed plasma, PC and PRC, that meet and exceed the North American blood processing standards.

### EXAMPLE 2

This example demonstrates a portion of filtered blood remaining in the filter housing after filtration can be recovered using a flushing solution and air.

Filter devices are prepared as described in Example 1, and arranged in a system as shown in FIG. 4. The system 100 includes a plurality of flexible blood bags, i.e., collection bag 10, receiving bag 1, satellite bags 13, 15, and 17, and flushing container 5. The system also includes filter device 50, and conduits 4, 6, 8, 12a-12c, 14, 16, and 18 provide fluid communication between the components of the system. The system also includes clamps associated with conduits 4, 6, and 8.

The filter device 50 has a hold up volume of about 50 mL. The flushing container 5 contains 20 mL of Citrate Phosphate Dextrose (CPD) anticoagulant solution, and 30 mL of sterile air. The conduit 4 between the collection bag (containing a unit of whole blood) and the filter housing of the device is 5 inches, and the length of the conduit 8 between the flushing container and the filter housing is 8 inches.

The conduit 6 between the filter housing and the receiving bag 11 (for containing the filtered blood) has a total length of 42 inches. This conduit is initially coiled, so that the distance between the filter housing and the receiving bag is 6 inches.

Units of anticoagulated whole blood (about 450 cc, plus 63 mL of CPD anticoagulant), disposed in collection bags 10, are filtered. The distance between the top of the collection bags (the bags are about 8.5 inches in height) and the top of the receiving bags, is about 17 inches (upstream conduit 5 inches, downstream coiled conduit 6 inches).

After filtration is completed and the collection bag 10 is emptied, the downstream conduit 6 is uncoiled and allowed to hang to its full length. The upstream conduit 4 is clamped between the filter device 5 and the collection bag 10. The clamp on the conduit 8 between the flushing container 5 and the filter device 50 is opened.

The flushing solution displaces about 30 mL of whole blood from the device. Flow from the device stops when air from the flushing container contacts the upstream surface of the filter in the housing. Since the volume of the anticoagulant in the flushing container is less than the hold up volume of the filter device, the anticoagulant does not pass into the receiving container.

The leukocyte-depleted whole blood is centrifuged, and further processed to provide PC and plasma in separate satellite containers. The red cell additive solution SAGM is passed from one of the containers into the receiving container, where it is mixed with the leukocyte-depleted red cells.

The leukocyte-depleted blood components have less than 1.0×10⁶ residual leukocytes per unit, and over 75% of the units of PC have at least 6×10¹⁰ platelets per unit. The measured parameters are normal.

This example shows whole blood can be efficiently leukocyte depleted via a single leukocyte depletion filter, while providing leukocyte-depleted processed plasma, PC and PRC, that meet and exceed the North American and European blood processing standards.

This example shows whole blood can be efficiently leukocyte depleted via a single leukocyte depletion filter, and additional whole blood can be recovered while providing leukocyte-depleted processed plasma, PC and PRC, that meet and exceed the North American and European blood processing standards.

### EXAMPLE 3

This example demonstrates filters according to another embodiment of the invention efficiently leukocyte-deplete whole blood while providing a desirable yield of platelets, red blood cells, and plasma.

A plurality of filters are prepared and arranged in housings to provide filter devices. Each filter includes two first porous filter elements and two second porous filter elements as generally described in Example 1, with the exception that the first elements each have 8 layers of fibrous PBT media (rather than the 9 layers as described in example 1). The first elements have a thickness of 48.8 mils (about 1239 micrometers). The second elements each have 6 layers of fibrous PBT media.

The CWSTs, basis weights, voids volumes, pore diameters, P8 values, and alternating arrangements, are the same as in Example 1.

Each filter is disposed in a housing, and units of anticoagulated whole blood (about 500 cc, plus 70 mL of Citrate Phosphate Double Dextrose (CP2D) anticoagulant), disposed in collection bags at a head height of 30 inches (76.2 cm), are filtered at room temperature.

The filtered (leukocyte-depleted) units received in the downstream receiving bags are centrifuged and separated according to standard North American blood bank procedures to provide packed red blood cells (PRC), plasma, and platelet concentrate (PC). The concentrations of residual white blood cells (WBCs) in each of the three components predetermined via flow cytometry, and the following parameters are measured: platelet activation, platelet extent of shape change (ESC), platelet hypotonic shock response (HSR), red cell hemolysis, red cell deformability, and plasma hemoglobin content. Additionally, the platelet count is determined for each unit of PC.

The leukocyte-depleted blood components have less than 5.0×10⁶ residual leukocytes per unit, and over 90% of the units of PC have at least 5.5×10¹⁰ platelets per unit. The measured parameters are normal.

This example shows whole blood can be efficiently leukocyte depleted via a single leukocyte depletion filter, while providing leukocyte-depleted processed plasma, PC and PRC, that meet and exceed the North American blood processing standards.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A biological fluid filter comprising:
at least one first porous leukocyte depletion filter element and at least one second porous leukocyte depletion filter element, the first and second filter elements each comprising a plurality of layers of fibrous media;
the first porous leukocyte depletion filter element having a different basis weight than the second porous leukocyte depletion filter element, each porous leukocyte depletion filter element having a basis weight of about 42 g/ft² (about 452 g/m²) or less;
wherein at least one porous leukocyte depletion element has a P8 value of at least about 14.5 inches (about 36.8 cm) of water.

2. A biological fluid filter comprising:
at least one first porous leukocyte depletion filter element and at least one second porous leukocyte depletion filter element, the first and second filter elements each comprising a plurality of layers of fibrous media;
the first filter element having a different basis weight and a higher P8 value than the second filter element;
at least one element having a P8 value of at least about 14.5 inches (about 36.8 cm) of water.

3. The filter of claim 2, wherein the first porous filter element has a P8 value of at least about 15 inches (about 38.1 cm) of water, and the second porous filter element has a P8 value of about 13.5 inches (about 34.3 cm) of water or less.

4. The filter of claim 2, wherein the first and second porous leukocyte depletion filter elements each have a critical wetting surface tension of at least about 75 dynes/cm (0.75 erg/mm²).

5. A biological fluid filter comprising:
at least one porous leukocyte depletion filter element comprising a plurality of layers of fibrous porous media, the element having a P8 of at least about 14.5 inches (about 36.8 cm) of water.

6. The filter of claim 5, wherein the leukocyte depletion filter element has a pore diameter in the range of from about 2 micrometers to about 6 micrometers.

7. The filter of claim 5, wherein the leukocyte depletion filter element has a P8 value of at least about 15 inches (about 38.1 cm) of water.

8. The filter of claim 7, wherein the leukocyte depletion filter element has a P8 in the range of from about 15 to about 18 inches (about 38.1 to about 45.7 cm) of water, and a basis weight in the range of from about 15 to about 30 g/ft² (about 161 to about 323 g/m²).

9. The filter of claim 8, wherein the leukocyte depletion filter element has a critical wetting surface tension of at least about 75 dynes/cm (0.75 erg/mm²).

10. The filter of claim 1, wherein each of the plurality of layers of fibrous media has an upstream surface and a downstream surface, and the filter includes adjacent layers having contacting surfaces wherein the contacting surfaces of the adjacent layers are not thermally or adhesively bound to each other.

11. The filter of claim 10, wherein each leukocyte depletion element has a critical wetting surface tension of at least about 85 dynes/cm (0.85 erg/mm²).

12. A method for processing biological fluid comprising:
passing a leukocyte-containing biological fluid through a biological fluid filter including at least one porous leukocyte depletion filter element comprising a plurality of layers of fibrous media, the element having a P8 of at least about 14.5 inches (about 36.8 cm) of water, to deplete leukocytes from the biological fluid.

13. The method of claim 12, wherein the leukocyte depletion filter element has a P8 of at least about 15 inches of water.

14. The method of claim 12, wherein the leukocyte-containing biological fluid is filtered within about 24 hours of collection.

15. The method of claim 12, wherein the biological fluid is filtered while maintaining a closed system.

16. A method for processing a biological fluid comprising:
passing a leukocyte-containing biological fluid through the filter of claim 1 to provide a leukocyte-depleted biological fluid.

17. The method of claim 16, wherein the leukocyte-depleted biological fluid contains less than 5×10⁶ residual leukocytes per unit of biological fluid.

18. (canceled)

19. The filter of claim 3, wherein the first and second porous leukocyte depletion filter elements each have a critical wetting surface tension of at least about 75 dynes/cm (0.75 erg/mm²).

20. The filter of claim 2, wherein each of the plurality of layers of fibrous media has an upstream surface and a downstream surface, and the filter includes adjacent layers having contacting surfaces wherein the contacting surfaces of the adjacent layers are not thermally or adhesively bound to each other.

21. The filter of claim 5, wherein each of the plurality of layers of fibrous media has an upstream surface and a downstream surface, and the filter includes adjacent layers having contacting surfaces wherein the contacting surfaces of the adjacent layers are not thermally or adhesively bound to each other.
